(19) United States
(12) Patent Application Publication
(10) Pub. No.: US 2026/0327124 A1
(43) Pub. Date: Oct. 22, 2026

(54) SYSTEM AND METHOD FOR CONTINUOUS CASTING OF SINGLE- OR MULTIPLE-LAYER COMPOSITE GLASS STRUCTURES

(71) Applicant: CORNING INCORPORATED, CORNING, NY (US)

(72) Inventors: David Alan Deneka, Corning, NY (US); Curtis Robert Fekety, Corning, NY (US); Irene Mona Peterson, Elmira Heights, NY (US); Butchi Reddy Vaddi, Sewickley, PA (US)

(21) Appl. No.: 19/104,797

(22) PCT Filed: Aug. 17, 2023
(86) PCT No.: PCT/US2023/030444

§ 371 Date: Feb. 19, 2025

Related U.S. Application Data
(60) Provisional application No. 63/400,811, filed on Aug. 25, 2022.

(51) Int. Cl. C03B 19/02

(52) U.S. Cl. CPC C03B 19/02

(57) ABSTRACT

A casting system in one or more embodiments is disclosed. The casting system includes a caster, a melting apparatus, and a feed system. The caster has a wall configured to define a casting passage that extends through the caster in a casting direction. The casting passage has an inlet and an outlet fluidically connected to the inlet. The melting apparatus is configured to deliver a continuous flow of molten glass to the inlet. The feed system is configured to feed a casting structure into the inlet and through the casting passage such that the molten glass delivered to the inlet contacts the casting structure and forms a cast glass composite structure continuously discharged from the outlet.

### CROSS-REFERENCE TO RELATED APPLICATIONS

This application claims the benefit of priority under 35 U.S.C. § 119 of U.S. Provisional Application No. 63/400,811 filed Aug. 25, 2022, the content of which is incorporated herein by reference in its entirety.

### FIELD

The present disclosure relates to glass casting and, more particularly, to continuous casting of single- or multiple-layer composite glass structures with optional internal and/or external features.

### BACKGROUND

Continuous casting of single- or multiple-layer composite glass structures with optional internal and/or external features is desirable. However, existing methods for forming such glass structures, particularly multiple-layer or laminated glass structures, may suffer from challenges. For example, one existing lab-scale method for forming laminated glass structures includes laying solid glass sheets on top of each other, which can be difficult due to trapped air between the sheets resulting in bubbles between the layers. Another existing lab-scale method for forming laminated glass structures includes pouring molten glass layers on top of each other, which can be problematic due to liquid-glass interactions and mixing and due to difficulty in controlling the poured layer thickness. Moreover, neither of these existing lab-scale methods is a continuous process. Existing production-scale methods for forming laminated glass structures, such as double fusion and double slot draw, are capital intensive and may require equipment that cannot (easily) be moved to other locations. Consequently, there is a need for a casting system that overcomes one or more of these challenges.

### SUMMARY

According to aspect (1), a casting system is provided. The casting system comprises: a caster having a wall configured to define a casting passage extending through the caster in a casting direction, the casting passage having an inlet and an outlet fluidically connected to the inlet; a melting apparatus configured to deliver a continuous flow of molten glass to the inlet; and a feed system configured to feed a casting structure into the inlet and through the casting passage such that the molten glass contacts the casting structure and forms a cast glass composite structure continuously discharged from the outlet.

According to aspect (2), the casting system of aspect (1) is provided, wherein the feed system is configured to feed the casting structure at a feed rate that corresponds to a casting rate at which the molten glass moves through the casting passage.

According to aspect (3), the casting system of aspect (1) or aspect (2) is provided, wherein the casting structure comprises a flexible glass sheet, the feed system configured to feed the flexible glass sheet along a center of the casting passage to form a core layer of the cast glass composite structure, the molten glass contacting both sides of the flexible glass sheet to form clad layers of the cast glass composite structure.

According to aspect (4), the casting system of aspect (3) is provided, wherein the flexible glass sheet is a redrawn sheet having a thickness in a range of from about 25 μm to about 400 μm.

According to aspect (5), the casting system of aspect (3) or aspect (4) is provided, wherein the flexible glass sheet has a composition that is different than a composition of the molten glass.

According to aspect (6), the casting system of aspect (1) or aspect (2) is provided, wherein the casting structure comprises two flexible glass sheets, the feed system configured to feed the two flexible glass sheets respectively along opposite sides of the casting passage to form clad layers of the cast glass composite structure, the molten glass contacting one side of each of the two flexible sheets to form a core layer the cast glass composite structure.

According to aspect (7), the casting system of aspect (6) is provided, wherein the two flexible glass sheets are redrawn sheets each having a thickness in a range of from about 25 μm to about 400 μm.

According to aspect (8), the casting system of aspect (6) or aspect (7) is provided, wherein the two flexible glass sheets have compositions that are different than a composition of the molten glass.

According to aspect (9), the casting system of any one of aspects (6) to (8) is provided, wherein the two flexible glass sheets have compositions that are different from one another.

According to aspect (10), the casting system of any one of aspects (1) to (9) is provided, wherein the melting apparatus is configured to deliver the molten glass to the inlet at a viscosity in a range of from about 5 P to about 200 P.

According to aspect (11), the casting system of any one of aspects (1) to (9) is provided, wherein the melting apparatus is configured to deliver the molten glass to the inlet at a viscosity that is less than a liquidus viscosity of the molten glass.

According to aspect (12), the casting system of aspect (1) or aspect (2) is provided, wherein the casting structure comprises a plurality of casting structures positioned in a fixed arrangement relative to one another.

According to aspect (13), the casting system of aspect (12) is provided, wherein the feed system comprises a chassis configured to be fed through the casting passage, the plurality of casting structures configured to be connected to the chassis to position the casting structures in the fixed arrangement.

According to aspect (14), the casting system of aspect (12) or aspect (13) is provided, wherein the plurality of casting structures comprises a first plurality of casting structures and a second plurality of casting structures, the feeding system configured to feed the first and second pluralities of casting structures sequentially one plurality at a time through the casting passage.

According to aspect (15), the casting system of any one of aspects (12) to (14) is provided, wherein the casting structures comprise internal structures configured to be surrounded by the molten glass such that the internal structures are spaced from all lateral surfaces of the cast glass composite structure.

According to aspect (16), the casting system of any one of aspects (12) to (15) is provided, wherein the casting structures comprise external structures configured to be exposed along at least one lateral surface of the cast glass composite structure.

According to aspect (17), the casting system of any one of aspects (12) to (16) is provided, wherein the casting structures are oriented one or more of perpendicular, parallel, and transverse to the casting direction.

According to aspect (18), the casting system of any one of aspects (12) to (17) is provided, wherein the casting structures are one or more of hollow tubes, solid rods, and spirals.

According to aspect (19), the casting system of any one of aspects (12) to (18) is provided, wherein the casting structures have compositions that are different than a composition of the molten glass.

According to aspect (20), the casting system of any one of aspects (12) to (19) is provided, wherein the casting structures are one or more of glass, glass ceramic, and metal.

According to aspect (21), the casting system of any one of aspects (12) to (20) is provided, wherein the casting structures are removable.

According to aspect (22), the casting system of any one of aspects (12) to (20) is provided, wherein the casting structures are dissolvable.

According to aspect (23), the casting system of aspect (1) or aspect (2) is provided, wherein the casting structure is a metal mesh.

According to aspect (24), the casting system of any one of the preceding aspects is provided, further comprising a temperature control system configured to control a temperature gradient of the caster, the temperature gradient comprising a first temperature proximate the inlet transitioning to a second temperature proximate the outlet, the first temperature higher than the second temperature.

According to aspect (25), the casting system of any one of the preceding aspects is provided, wherein the caster has a width and a thickness that is less than the width.

According to aspect (26), the casting system of any one of the preceding aspects is provided, wherein the caster is configured to be supported on a moveable cart.

According to aspect (27), the casting system of any one of the preceding aspects is provided, wherein the casting passage is oriented vertically.

### BRIEF DESCRIPTION OF THE DRAWINGS

FIG. 1 is a schematic perspective view of a casting system comprising a caster with a casting passage, a melting apparatus that delivers molten glass to the casting passage, and a feed system configured to feed various embodiments of a casting structure through the casting passage to form a continuous cast glass composite structure, the casting structure shown as two flexible glass sheets;

FIG. 2 is a cross-sectional view of the casting system of FIG. 1;

FIG. 3 is an image of a portion of the continuous cast glass composite structure formed via the casting system and casting structure of FIG. 1;

FIG. 4 is a schematic perspective view of the casting system of FIG. 1 with the casting structure shown as a (single) flexible glass sheet;

FIG. 5 is a cross-sectional view of the casting system of FIG. 4;

FIG. 6 is a schematic perspective view of the casting system of FIG. 1 further comprising a moveable chassis configured to position a plurality of the casting structures, the casting structures shown as horizontal glass rods in one configuration;

FIG. 7 is a schematic perspective view of the casting system of FIG. 6, the casting structures shown as horizontal glass rods in another configuration;

FIG. 8 is a schematic perspective view of the casting system of FIG. 6, the casting structures shown as horizontal glass tubes;

FIG. 9 is a schematic perspective view of the casting system of FIG. 6, the casting structures shown as vertical glass tubes;

FIG. 10 is a schematic perspective view of the casting system of FIG. 6, the casting structures shown as glass spirals;

FIG. 11 is a schematic perspective view of the casting system of FIG. 6, the casting structures shown as contoured glass bars in one configuration and disposed along short sides of the casting passage;

FIG. 12 is a schematic perspective view of the casting system of FIG. 6, the casting structures shown as contoured glass bars in another configuration and disposed along long sides of the casting passage; and FIG. 13 is a schematic perspective view of the casting system of FIG. 6, the casting structure shown as a metal mesh.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein-for example up, down, right, left, front, back, top, bottom, above, below, and the like-are made only with reference to the figures as drawn and are not intended to imply absolute orientation. The terms “vertical,” “vertically,” and variations thereof as used herein mean an orientation that coincides approximately to the direction along which the force of gravity acts.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

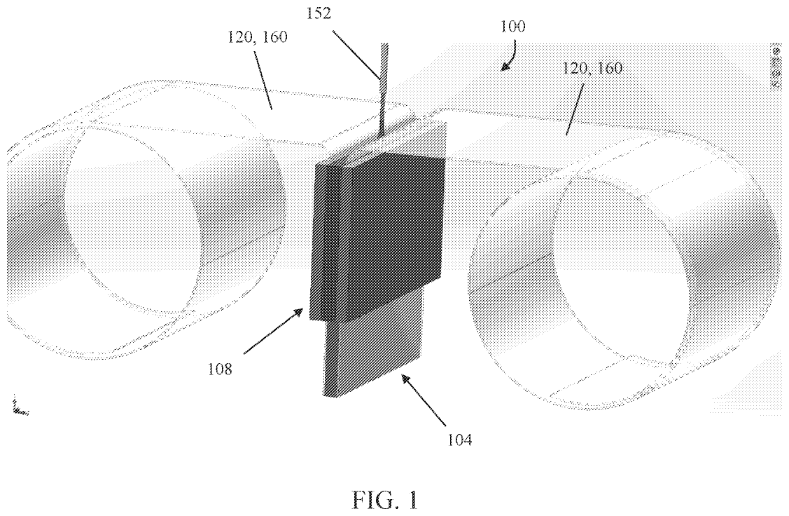

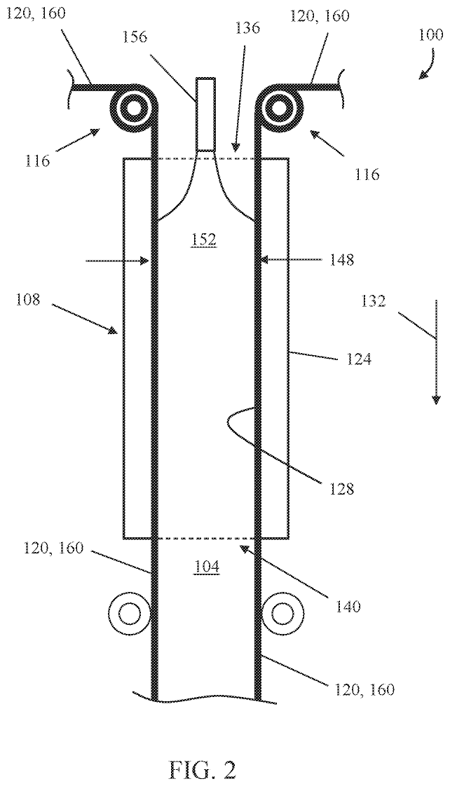

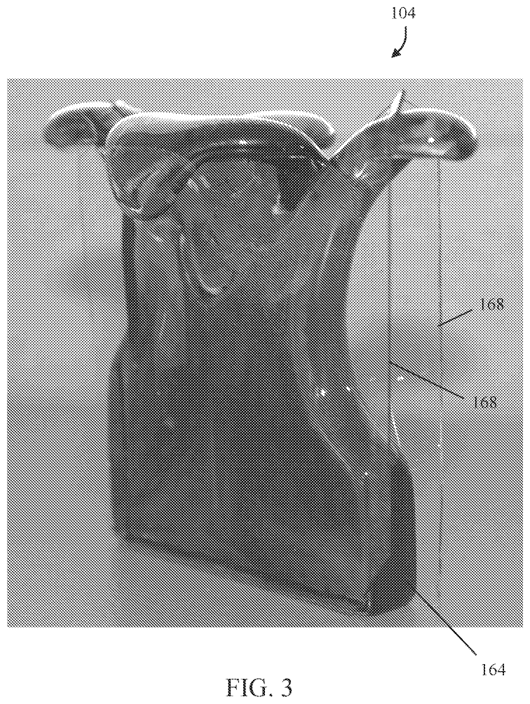

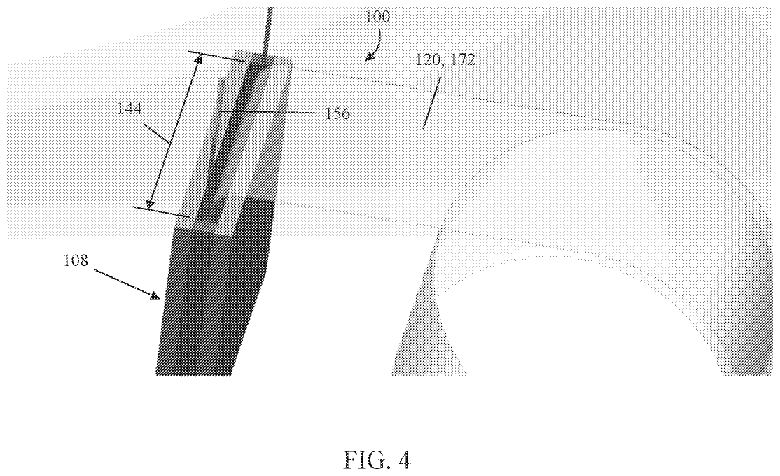

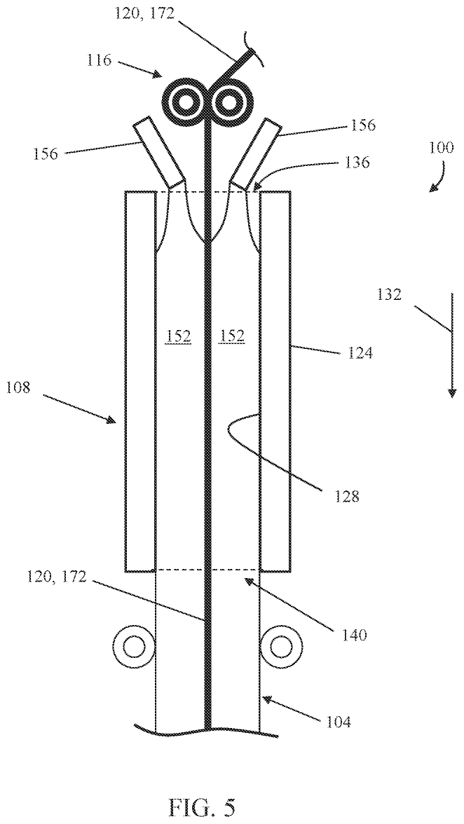

FIGS. 1-13 depict embodiments of a (continuous) casting system 100 for forming a continuous cast glass composite structure 104. The casting system 100 comprises a caster 108, a melting apparatus (not shown), a feed system 116, and one or more casting structures 120. The caster 108 has a wall 124 configured to define a casting passage 128 that extends through the caster 108 in a casting direction (arrow 132). The casting passage 128 has an inlet 136 at one end of the caster 108 and an outlet 140 fluidically connected to the inlet 136 at an opposite end of the caster 108, as shown using dotted line type in FIGS. 2 and 5. The casting passage 128 can have any suitable cross-sectional shape that permits molten glass delivered to the inlet 136 to cool and form cast glass that is discharged from the outlet 140. In the embodiment shown, the casting passage 128 has a rectangular cross-sectional shape with a width 144 (FIG. 4) and a thickness 148 (FIG. 2) that is less than the width 144. In embodiments, the casting passage 128 can have other cross-sectional shapes with corresponding dimensions. In embodiments, the casting passage 128 is oriented vertically. In embodiments, the caster 108 is configured to be supported on a moveable cart such that the casting system is portable.

The melting apparatus is configured to deliver a continuous flow of molten glass 152 to the inlet 136. In embodiments, the melting apparatus comprises an exit element 156 that delivers the molten glass 152 to the inlet 136. The exit element 156 can have a maximum dimension in a direction parallel to the width 144 of the casting passage 128, which maximum dimension is the approximate width of the molten glass 152 as it leaves the melting apparatus and flows into the caster 108. Depending on the viscosity of the molten glass 152 flowing from the melting apparatus, it can have a width that is about the same as, or smaller, than the maximum dimension of the exit element 156. In embodiments, the maximum dimension of the exit element 156 is less than or equal to the width 144 of the caster 108. In embodiments, the maximum dimension of the exit element 156 can be larger than the width 144 of the caster 108, e.g., for compositions of the molten glass 152 that have a relatively low upper liquidus viscosity (e.g., 5 P to 5000 P). In particular, such glasses upon melting can “neck” as they leave the exit element 156 of the melting apparatus, allowing them to flow into a caster 108 having a width that is smaller in dimension than the maximum dimension of the exit element 156 of the melting apparatus.

In embodiments, the molten glass 152 is derived from a glass composition including borosilicate glasses, aluminoborosilicate glasses, aluminosilicate glasses, fluorosilicate glasses, phosphosilicate glasses, fluorophosphate glasses, sulfophosphate glasses, germanate glasses, vanadate glasses, borate glasses, and phosphate glasses.

The feed system 116 is configured to feed a casting structure 120 into the inlet 136 and through the casting passage 128 such that the molten glass 152 contacts the casting structure 120 and forms the continuous cast glass composite structure 104, which is continuously discharged from the outlet 140. Embodiments of the feed system 116 are described below in connection with embodiments of the casting structure 120. The feed system 116 is configured to feed the casting structure 120 at a feed rate that corresponds to a casting rate at which the molten glass 152 moves through the casting passage 128 and thereafter cools and exits the outlet 140.

Referring to FIGS. 1 and 2, an embodiment is shown in which the casting structure 120 comprises two flexible glass sheets 160. The feed system 116 is configured to feed the two flexible glass sheets 160 respectively along opposite sides of the casting passage 128 to form clad layers of the continuous cast glass composite structure 104. The two flexible glass sheets 160 are depicted as thick lines in FIG. 2. In embodiments, the feed system 116 can comprise one or more rollers provided for each flexible glass sheet and configured to guide the respective glass sheets through the casting passage 128. The flow of the molten glass 152 is delivered centrally in the casting passage 128 such that molten glass 152 contacts one side of each of the two flexible sheets 160 to form a core layer of the continuous cast glass composite structure 104. In the embodiment of FIGS. 1 and 2, the continuous cast glass composite structure 104 that exits the outlet 140 is in the form of a laminate glass sheet. FIG. 3 is an image of a portion of such a laminate glass sheet, which comprises core layer 164 of the cast glass and surrounded by clad layers 168 of the flexible glass sheets 160.

In embodiments, the two flexible glass sheets 160 are redrawn sheets each having a thickness in a range of from about 25 μm to about 400 μm, or from about 35 μm to about 300 μm, or from about 45 μm to about 250 μm, or from about 50 μm to about 200 μm, or ranges that are in between, larger, or smaller than those indicated herein.

In embodiments, the two flexible glass sheets 160 can have compositions that are the same as or different than a composition of the molten glass 152. In embodiments, the two flexible glass sheets 160 have compositions that are same or different from one another.

In one embodiment, the molten glass 152 has a composition with a high refractive index and the two flexible glass sheets 160 have a composition corresponding to Corning Eagle XG® glass. With this combination of compositions, the core layer has a higher refractive index than the clad layers, which would result in a unique planar waveguide for use in optical applications.

Referring to FIGS. 4 and 5, an embodiment is shown in which the casting structure 120 comprises a (single) flexible glass sheet 172. The feed system 116 is configured to feed the flexible glass sheet 172 along a center of the casting passage 128 to form a core layer of the continuous cast glass composite structure 104. The flexible glass sheet 172 is depicted as a thick line in FIG. 5. In embodiments, the feed system 116 can comprise one or more rollers configured to guide the flexible glass sheet 172 through the casting passage 128. The flow of the molten glass 152 is delivered such that the molten glass 152 contacts both sides of the flexible glass sheet 172 to form clad layers of the continuous cast glass composite structure 104. In embodiments, the molten glass 152 can be delivered from a plurality of exit elements 156, such as shown in the embodiment of FIG. 5. In the embodiment of FIGS. 4 and 5, the continuous cast glass composite structure 104 that exits the outlet 140 is in the form of a laminate glass sheet.

In embodiments, the flexible glass sheet 172 is a redrawn sheet that has a thickness in a range of from about 25 μm to about 400 μm, or from about 35 μm to about 300 μm, or from about 45 μm to about 250 μm, or from about 50 μm to about 200 μm, or ranges that are in between, larger, or smaller than those indicated herein.

In embodiments, the flexible glass sheet 172 can have a composition that is the same as or different than a composition of the molten glass 152.

In the embodiments of FIGS. 1-5, the melting apparatus is configured to deliver the molten glass 152 to the inlet 136 at a viscosity in a range of from about 5 P to about 200 P, or from about 6 P to about 175 P, or from about 7 P to about 150 P, or from about 8 P to about 125 P, or from about 9 P to about 100 P, or from about 10 P to about 100 P, or ranges that are in between, larger, or smaller than those indicated herein. In the embodiments of FIGS. 1-5, the melting apparatus is configured to deliver the molten glass 152 to the inlet 136 at a viscosity that is less than a liquidus viscosity of the molten glass 152.

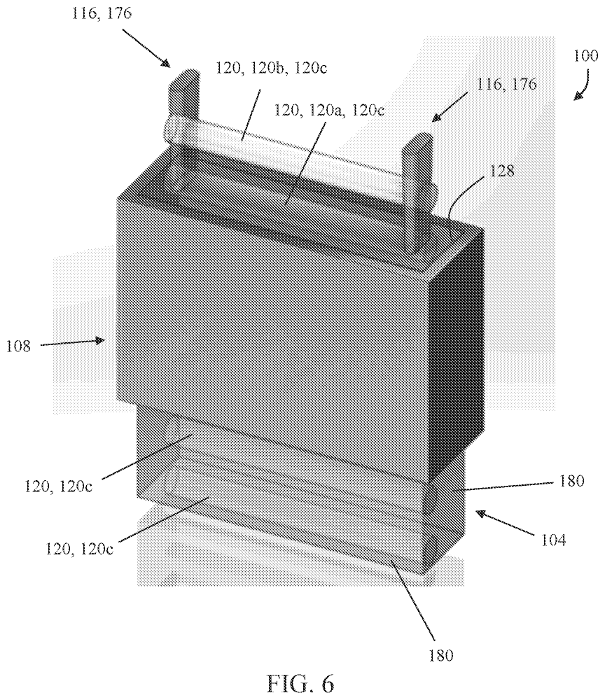

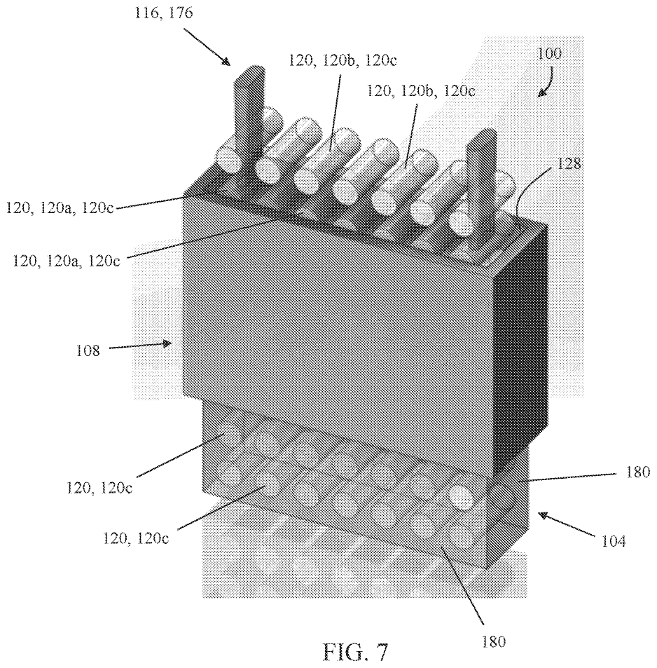

Referring to FIGS. 6-13, embodiments are shown in which the casting structure 120 comprises a plurality of casting structures 120 positioned in a fixed arrangement relative to one another. In such embodiments, the feed system 116 can comprise a holding structure or chassis 176 configured to be fed through the casting passage 128. The plurality of casting structures 120 are configured to be connected to the chassis 176 to position the casting structures 120 in the fixed arrangement. In the embodiments of FIGS. 6-13, the feed system 116 is configured to feed the chassis 176 at a feed rate that corresponds to the casting rate at which the molten glass 152 moves through the casting passage 128 and thereafter cools and exits the outlet 140. In the embodiments of FIGS. 6-13, the casting structures 120 can comprise virtually any object that can be secured in the caster 108, such as secured via the chassis 176, and retain shape integrity at high temperature, as long as the casting structures 120 do not block the flow of the molten glass 152.

In embodiments, such as shown in FIG. 6, the plurality of casting structures 120 comprises a first casting structure 120a and a second casting structure 120b. The feeding system 116 is configured to feed the first casting structure 120a and the second casting structure 120b sequentially one after the other through the casting passage 128.

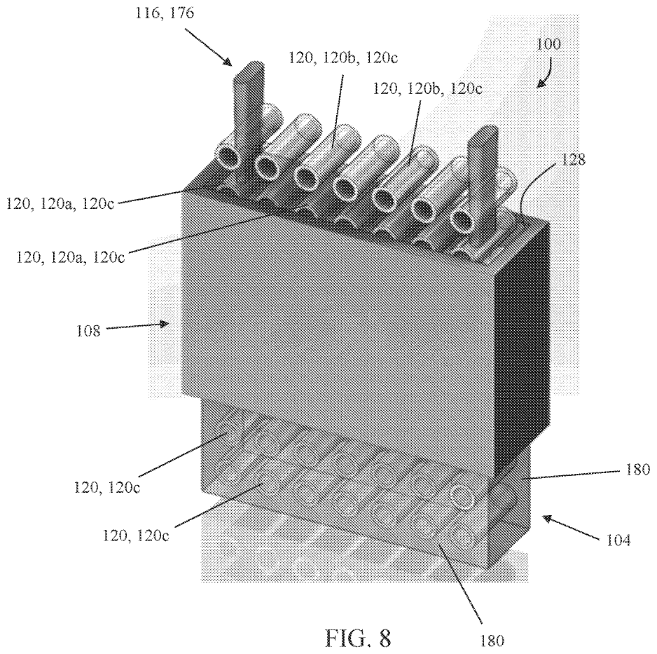

In embodiments, such as shown in FIGS. 7 and 8, the plurality of casting structures 120 comprises a first plurality of casting structures 120a and a second plurality of casting structures 120b. The feeding system 116 configured to feed the first and second pluralities of casting structures 120a, 120b sequentially one plurality at a time through the casting passage 128.

Referring to FIGS. 6-10, embodiments are shown in which the casting structures 120 comprise internal structures 120c configured to be surrounded by the molten glass 152 such that the internal structures are spaced from all lateral surfaces 180 of the cast glass composite structure 104. In such embodiments, the casting structures 120 can be exposed to one or more axial surfaces at axial ends of the cast glass composite structure 104.

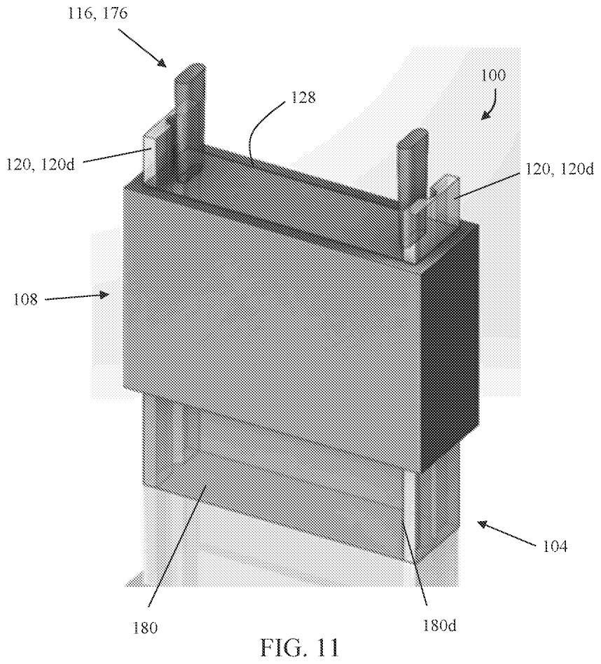

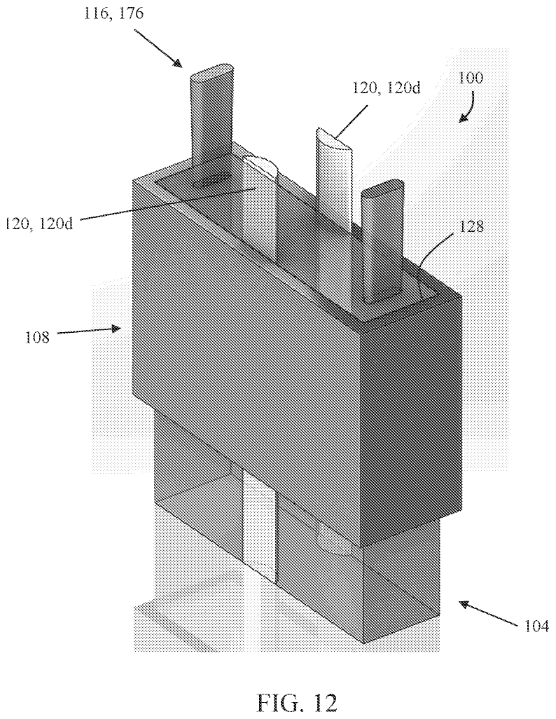

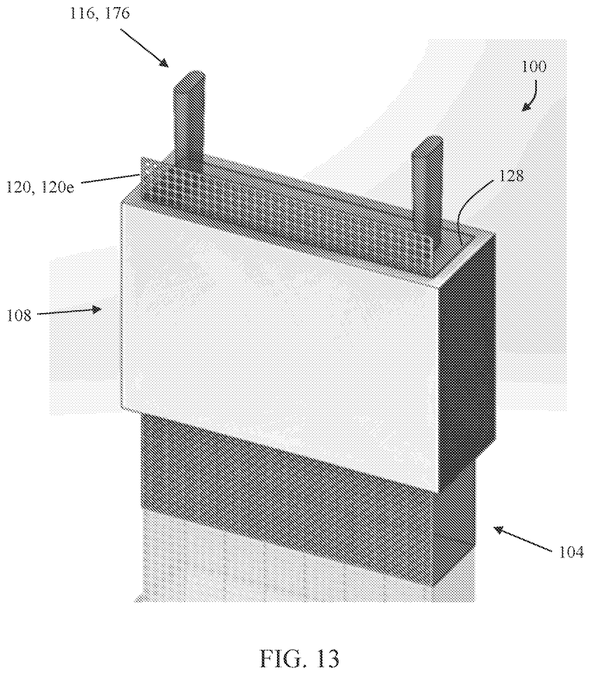

Referring to FIGS. 11 and 12, embodiments are shown in which the casting structures 120 comprise external structures 120d configured to be exposed along at least one lateral surface 180d of the cast glass composite structure 104. In embodiments, the external structures 120d can be contoured glass bars introduced along the sides of casting passage 128. In embodiments, the contoured glass bars be formed from a lost-glass composition and thereafter etched away so as to leave a contoured shape on the cast glass composite structure 104.

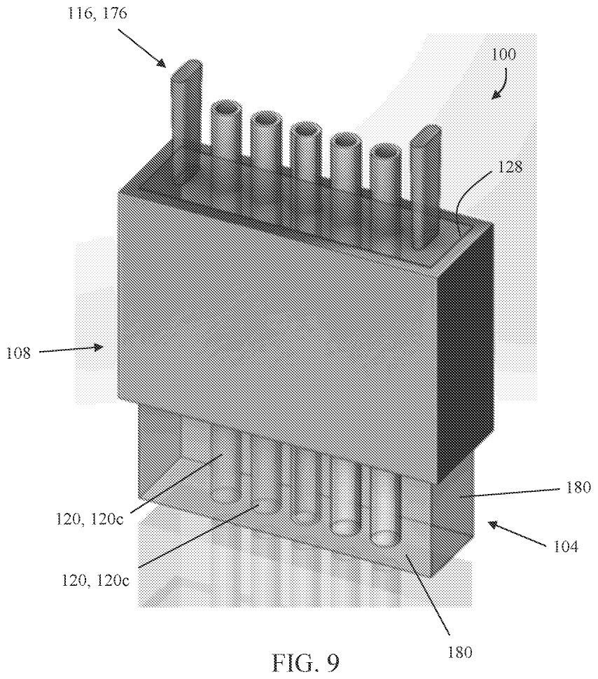

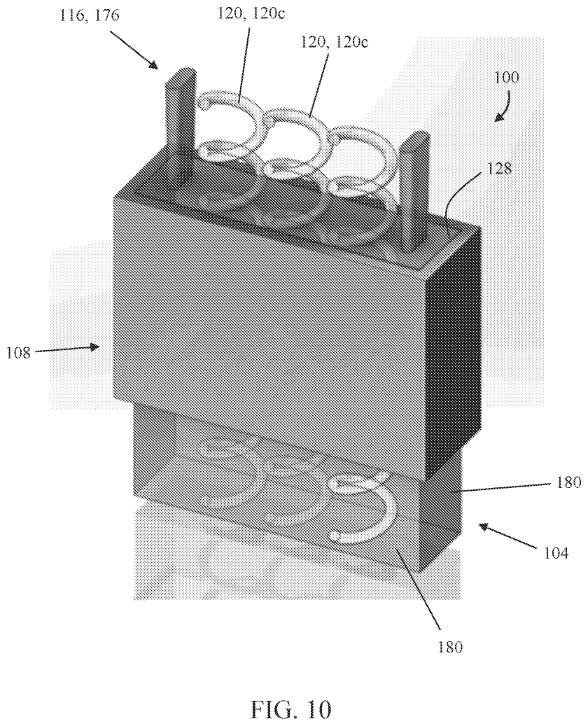

In the embodiments of FIGS. 6-12, the casting structures 120 are oriented one or more of perpendicular/horizontal (FIGS. 6-8), parallel/vertical (FIGS. 9-12), and transverse to the casting direction 132. In the embodiments of FIGS. 6-10, the casting structures 120 are one or more of hollow tubes (FIGS. 8 and 9), solid rods (FIGS. 6 and 7), and spirals (FIG. 10).

In the embodiments of FIGS. 6-12, the casting structures 120 have compositions that are the same as or different than a composition of the molten glass 152. In the embodiments of FIGS. 6-12, the casting structures 120 comprise one or more of glass, glass ceramic, and metal. In embodiments in which the casting structures 120 comprise glass ceramic and/or metal, the glass ceramic and/or the metal are selected with appropriate working temperature and thermal expansions for compatibility with the molten glass 152.

In the embodiments of FIGS. 6-12, the casting structures 120 are removable, dissolvable, or both removeable and dissolvable. In one embodiment in which the casting structure 120 is an internal structure 120c that is formed from a removable/dissolvable material, such as graphite, the graphite internal structure is burned out after casting, leaving one or more hollow channels depending on the configuration of the internal structure 120c.

Referring to FIG. 13, an embodiment is shown in which the casting structure 120 is a metal mesh 120e. A cast glass composite structure 104 with the metal mesh 120e can have unique electrical and thermal properties (e.g., thermoelectric).

In embodiments, the casting system 100 further comprises a temperature control system (not shown) configured to control a temperature gradient of the caster 108. In such embodiments, the temperature gradient can comprise a first temperature proximate the inlet 136 that gradually or sharply transitioning to a second temperature proximate the outlet 140. In embodiments, the first temperature is higher than the second temperature.

Embodiments of the casting system 100 and associated methods for forming the continuous cast glass composite structure 104 as disclosed herein have numerous advantages. The embodiments disclosed herein provide the ability to introduce glass features such as holes, rods of different compositions, spirals, etc. and form the corresponding cast glass composite structure in a continuous manner. The embodiments disclosed herein provide the ability to introduce metal or ceramic features such as holes, rods of different compositions, spirals, etc. and form the corresponding cast glass composite structure in a continuous manner.

The embodiments disclosed herein provide the ability to form a non-fusion formable laminated sheet. The core glass can be cast at a low viscosity and can be lower than the liquidous viscosity. The cladding sheet(s) can be redrawn sheets of a thickness in a range of from about 50 μm to about 200 μm. The cladding sheet(s) can be a preform formed by various sheet forming methods. The embodiments disclosed herein provide the ability to make laminate glass from glasses with short viscosity curves or a strong tendency to crystallize during forming. The embodiments disclosed herein provide the ability to make laminate glass from glasses whose forming viscosity temperatures are far apart.

The embodiments disclosed herein provide the ability to utilize different glass delivery methods, such as day tanks or crucible pours for either clad or core layers. Such versatility in delivery methods allows for different glass compositions to be used without lengthy changeovers of large tanks.

The embodiments disclosed herein enable processes that can form products with unusual attributes that may not be possible to make with other techniques. For instance, two or more glasses with differing indices of refraction can produce optical components with unusual shapes (quantum dots or 3D waveguides). Casting around an internal structure that can be removed or dissolved later (such as soluble glass, graphite, or carbon fiber) can make continuous hollow channels with desired shapes and dimensions (e.g., mini reactors). Casting around surface structures that can be removed or dissolved later (such as soluble glass, graphite, or carbon fiber) can make continuous sheet or bar with desired surface shape without costly machining. Casting around a metal mesh can produce bodies with unique electrical and thermal properties (thermoelectric).

### Example

The various embodiments of the present disclosure can be better understood by reference to the following Example which is offered by way of illustration. The present disclosure is not limited to the Example given herein. The casting structure(s) 120 is/are configured to be positioned inside the caster 108 with sufficient length to feed the entire length of the continuous cast glass composite structure 104 to be formed by the casting system 100.

When melting apparatus begins to deliver the flow of the molten glass 152 to the inlet 136 of the casting passage 128 and fills the caster 108 to a specified level, the feed system 116 is moved at a feed rate (e.g., about 1.5 in/min). As the molten glass 152 cools and hardens, the casting structure(s) inside the caster 108 adhere to the cast glass and are pulled along at the feed rate. In an embodiment in which the casting passage 128 is configured with 400 mm×25 mm cross-sectional shape, the melting apparats is configured to deliver the molten glass 152 at a flow rate of about 150 lb/hr. In an embodiment, as the continuous cast glass composite structure 104 exits the caster 108, it is delivered into an annealing oven, set to anneal at the cast glass conditions (e.g., approximately 600 °C to 625 °C, with a cool down rate of 200 °C/hr or slower. The resulting cast structure can be shaped afterwards by drawing, bending, etc., or further treated to remove sacrificial components (by dissolution or oxidation).

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

1. A casting system, comprising:
a caster having a wall configured to define a casting passage extending through the caster in a casting direction, the casting passage having an inlet and an outlet fluidically connected to the inlet;
a melting apparatus configured to deliver a continuous flow of molten glass to the inlet; and
a feed system configured to feed a casting structure into the inlet and through the casting passage such that the molten glass contacts the casting structure and forms a cast glass composite structure continuously discharged from the outlet.

2. The casting system of claim 1, wherein the feed system is configured to feed the casting structure at a feed rate that corresponds to a casting rate at which the molten glass moves through the casting passage.

3. The casting system of claim 1, wherein the casting structure comprises a flexible glass sheet, the feed system configured to feed the flexible glass sheet along a center of the casting passage to form a core layer of the cast glass composite structure, the molten glass contacting both sides of the flexible glass sheet to form clad layers of the cast glass composite structure.

4. The casting system of claim 3, wherein the flexible glass sheet is a redrawn sheet having a thickness in a range of from about 25 μm to about 400 μm.

5. The casting system of claim 3, wherein the flexible glass sheet has a composition that is different than a composition of the molten glass.

6. The casting system of claim 1, wherein the casting structure comprises two flexible glass sheets, the feed system configured to feed the two flexible glass sheets respectively along opposite sides of the casting passage to form clad layers of the cast glass composite structure, the molten glass contacting one side of each of the two flexible sheets to form a core layer the cast glass composite structure.

7. The casting system of claim 6, wherein the two flexible glass sheets are redrawn sheets each having a thickness in a range of from about 25 μm to about 400 μm.

8. The casting system of claim 6, wherein the two flexible glass sheets have compositions that are different than a composition of the molten glass.

9. The casting system of claim 6, wherein the two flexible glass sheets have compositions that are different from one another.

10. The casting system of claim 1, wherein the melting apparatus is configured to deliver the molten glass to the inlet at a viscosity in a range of from about 5 P to about 200 P.

11. The casting system of claim 1, wherein the melting apparatus is configured to deliver the molten glass to the inlet at a viscosity that is less than a liquidus viscosity of the molten glass.

12. The casting system of claim 1, wherein the casting structure comprises a plurality of casting structures positioned in a fixed arrangement relative to one another.

13. The casting system of claim 12, wherein the feed system comprises a chassis configured to be fed through the casting passage, the plurality of casting structures configured to be connected to the chassis to position the casting structures in the fixed arrangement.

14. The casting system of claim 12, wherein the plurality of casting structures comprises a first plurality of casting structures and a second plurality of casting structures, the feeding system configured to feed the first and second pluralities of casting structures sequentially one plurality at a time through the casting passage.

15. The casting system of claim 12, wherein the casting structures one or more of:
comprise internal structures configured to be surrounded by the molten glass such that the internal structures are spaced from all lateral surfaces of the cast glass composite structure,
comprise external structures configured to be exposed along at least one lateral surface of the cast glass composite structure,
are oriented one or more of perpendicular, parallel, and transverse to the casting direction,
are one or more of hollow tubes, solid rods, and spirals,
have compositions that are different than a composition of the molten glass,
are one or more of glass, glass ceramic, and metal,
are removable, and
are dissolvable.

16.-22. (canceled)

23. The casting system of claim 1, wherein the casting structure is a metal mesh.

24. The casting system of claim 1, further comprising a temperature control system configured to control a temperature gradient of the caster, the temperature gradient comprising a first temperature proximate the inlet transitioning to a second temperature proximate the outlet, the first temperature higher than the second temperature.

25. The casting system of claim 1, wherein the caster has a width and a thickness that is less than the width.

26. The casting system of claim 1, wherein the caster is configured to be supported on a moveable cart.

27. The casting system of claim 1, wherein the casting passage is oriented vertically.
